(19) United States
(12) Patent Application Publication
(10) Pub. No.: US 2025/0291612 A1
(43) Pub. Date: Sep. 18, 2025

(54) METHODS, APPARATUSES AND COMPUTER PROGRAM PRODUCTS FOR PROVIDING HIGHLY PERSONALIZED AND ADAPTABLE USER INTERFACES

(71) Applicant: META PLATFORMS, INC., Menlo Park, CA (US)

(72) Inventors: Andre Cassal, Eagle, ID (US); Kristina Alexis Oliva, London (GB); Hande Buberci, Amsterdam (NL)

(21) Appl. No.: 19/076,817

(22) Filed: Mar. 11, 2025

Related U.S. Application Data
(60) Provisional application No. 63/564,840, filed on Mar. 13, 2024.

(51) Int. Cl. G06F 9/451

(52) U.S. Cl. CPC G06F 9/451

(57) ABSTRACT

A system and method to generate personalized user interfaces are provided. The system may determine one or more items of demographic content associated with at least one user to obtain one or more user attributes. The system may determine one or more signals associated with a communication device associated with the at least one user or one or more user activities associated with the communication device or associated with at least one application associated with the communication device. The system may generate, based on the determined user attributes and the determined one or more signals, a first user interface, including content items and one or more elements, that is tailored or personalized to the at least one user.

### CROSS-REFERENCE TO RELATED APPLICATIONS

This application claims priority to U.S. Provisional Application No. 63/564,840, filed Mar. 13, 2024, entitled, “Highly Personalized and Adaptable User Interface Design,” the contents of which is incorporated by reference herein in its entirety.

### TECHNOLOGICAL FIELD

Examples of the present disclosure may relate generally to methods, apparatuses and computer program products to provide artificial intelligence (AI) generated customizable user interfaces that may be adaptable or tailored to needs and/or preferences of different users.

### BACKGROUND

Designing user experiences for people at scale may present a unique set of challenges for some social networks. In needing to serve users who all may have different needs, some product designers have historically or traditionally prioritized the most important problems to solve. While this has largely led to social networks being usable by the majority of users, there may still be missing gaps in a user experience associated with a social network that may not be resolved with the same amount of depth.

As such, it may be beneficial to provide efficient and reliable mechanisms that provide opportunities to improve the usability and accessibility of networks, as well as safeguards to mitigate undesirable user experiences associated with a network.

### BRIEF SUMMARY

Some examples of the present disclosure may provide techniques and mechanisms to facilitate the use of AI to generate adaptable or tailored user interfaces based on preferences and/or needs of different users. In some examples, the exemplary aspects of the present disclosure may utilize one or more signals to dynamically change/adjust or modify content, components and/or design elements of user interfaces. The exemplary aspects of the present disclosure may provide tailored and user specific user interfaces associated with specific users of a network. In this regard, the exemplary aspects may diverge from the stagnant conventional/existing one-size-fits-all user interfaces for all users of a platform.

Some exemplary aspects of the present disclosure may provide a machine learning (ML) model and/or artificial intelligence model that may alter a user interface associated with a device(s) and/or an application(s) and may be trained based, in part, on determined attributes of users of user interfaces associated with the devices and/or applications. The machine learning model and/or the AI model may determine the attributes based on one or more signals received by users of user interfaces associated with the devices or applications. The signals may include, but are not limited to, a user's activity on one or more devices, a network connection(s) of a device(s) associated with a user(s), one or more specifications of a device(s) associated with a user(s), and/or a user's activity on, or associated with, one or more applications as well as suitable contextual content associated with a user(s) and/or a communication device(s) associated with the user(s) that may be utilized. The determined attributes of the user may include the scrolling speed associated with a user interface, frequency of use of one or more components of the one or more applications. The determined attributes may further be based on demographic information associated with a user(s) and/or personal goals of a user(s). The machine learning model and/or the AI model may utilize the determined attributes of a user to alter a user interface associated with a device(s) and/or application(s) being accessed by a user(s). Additionally, for a same device(s) (e.g., device type) and/or application(s), the machine learning model and/or AI model may alter a user interface differently based on the determined attributes of different users. In this regard, the exemplary aspects of the present disclosure may generate a personalized/tailored user interface or user-specific user interface for various users associated with a network, platform, or the like.

In one example of the present disclosure, a method is provided. The method may include determining one or more items of demographic content associated with at least one user to obtain one or more user attributes. The method may further include determining one or more signals associated with a communication device associated with the at least one user or one or more user activities associated with the communication device or associated with at least one application associated with the communication device. The method may further include generating, based on the determined user attributes and the determined one or more signals, a first user interface. The first user interface may include content items and one or more elements, that is tailored or personalized to the at least one user.

In another example of the present disclosure, an apparatus is provided. The apparatus may include one or more processors and a memory including computer program code instructions. The memory and computer program code instructions are configured to, with at least one of the processors, cause the apparatus to at least perform operations including determining one or more items of demographic content associated with at least one user to obtain one or more user attributes. The memory and computer program code are also configured to, with the processor(s), cause the apparatus to determine one or more signals associated with a communication device associated with the at least one user or one or more user activities associated with the communication device or associated with at least one application associated with the communication device. The memory and computer program code are also configured to, with the processor(s), cause the apparatus to generate, based on the determined user attributes and the determined one or more signals, a first user interface. The first user interface may include content items and one or more elements, that is tailored or personalized to the at least one user.

In yet another example of the present disclosure, a computer program product is provided. The computer program product may include at least one non-transitory computer-readable medium including computer-executable program code instructions stored therein. The computer-executable program code instructions may include program code instructions configured to determine one or more items of demographic content associated with at least one user to obtain one or more user attributes. The computer program product may further include program code instructions configured to determine one or more signals associated with a communication device associated with the at least one user or one or more user activities associated with the communication device or associated with at least one application associated with the communication device. The computer program product may further include program code instructions configured to generate, based on the determined user attributes and the determined one or more signals, a first user interface. The first user interface may include content items and one or more elements, that is tailored or personalized to the at least one user.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

A summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4A is a diagram illustrating a baseline user interface in accordance with exemplary aspects of the present disclosure.

FIG. 4B is a diagram illustrating a variation or update of a generated user interface tailored to a same user associated with the baseline user interface of FIG. 4A in accordance with exemplary aspects of the present disclosure.

FIG. 4C is a diagram illustrating another variation or update of a generated user interface of a same user associated with the baseline user interface of FIG. 4A and/or the user interface of FIG. 4B in accordance with exemplary aspects of the present disclosure.

FIG. 5A is a diagram illustrating another baseline user interface in accordance with exemplary aspects of the present disclosure.

FIG. 5B is a diagram illustrating another generated user interface tailored to a same user associated with the baseline user interface of FIG. 5A in accordance with exemplary aspects of the present disclosure.

FIG. 5C is yet another diagram illustrating another generated user interface tailored to a same user associated with the baseline user interface of FIG. 5A and/or the user interface of FIG. 5B in accordance with exemplary aspects of the present disclosure.

FIG. 6 illustrates an example of a machine learning framework in accordance with one or more examples of the present disclosure.

FIG. 7 illustrates an example flowchart illustrating operations for generating a personalized user interface in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a baseline user interface may refer to an initially generated user interface (e.g., a standard user interface or reference user interface), which may be a default or starting point design of a digital product (e.g., a website(s), an application(s) (apps), etc.). The baseline user interface may include content items and fundamental visual elements such as typography, layout(s), color scheme(s), and interactive components (e.g., buttons, search fields), spacing(s), other fields and/or the like that may serve as an initial/starting point for further customization of the baseline user interface to one or more other user interfaces. A baseline user interface may be tailored to a specific user. In some examples, a baseline user interface may have some standard features common to various use cases and may have other features and/or elements that are customizable to meet the needs and/or desires of specific users and/or specific use cases.

It is to be understood that the methods and systems described herein are not limited to specific methods, specific components, or to particular implementations. It is also to be understood that the terminology used herein is for the purpose of describing particular embodiments only and is not intended to be limiting.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

Traditionally, some existing product design systems may prioritize the most important problems to solve for user interface design. Some traditional/conventional user interface designs may be usable by a majority of users associated with a network, platform, or the like. However, there may be gaps in the user experience of users that may not have been resolved by conventional approaches that typically provide one-size-fits-all user interfaces for each of the users associated with a network or platform. The one-size-fits-all user interfaces may not fit the needs and preferences of users and thus may result in a cumbersome user experience. Resolving some of the gaps may improve usability or accessibility of features (e.g., products, services, etc.) of a network. Resolving the gaps may mitigate negative or undesirable user experiences. The exemplary aspects of the present disclosure may utilize AI and/or ML to scale the ability to solve the problems of the gaps by diverging from a one-size-fits-all user interface for each of the users of a network, or platform. In this regard, the exemplary aspects of the present disclosure may utilize AI and/or ML to create user interfaces that may change to adapt to the needs, preferences, or desires of each user associated with a network, or platform which, may result in a user experience that is unique/tailored for a specific user(s). One or more determined signals may be utilized by the exemplary aspects of the present disclosure to change and/or modify content, components, and design elements of a user interface dynamically to generate and/or provide adaptive user interfaces to specific users.

To increase usability or accessibility of a device(s) and/or an application(s), AI and/or ML may customize the content and layout of a user interface to be tailored for a user's needs based on determined signals such as, for example, user activity and/or user preferences. These signals may be provided to a framework (e.g., a design framework), which may be utilized by an AI model and/or ML model to determine which visual components may be the desired/preferred visual components to show, in a preferred layout, including preferred content for a specific person in a tailored user interface. In this regard, the AI model and/or the ML model may design or create a user interface for a specific/particular user(s) based, in part, on the determined signals.

### Exemplary System Architecture

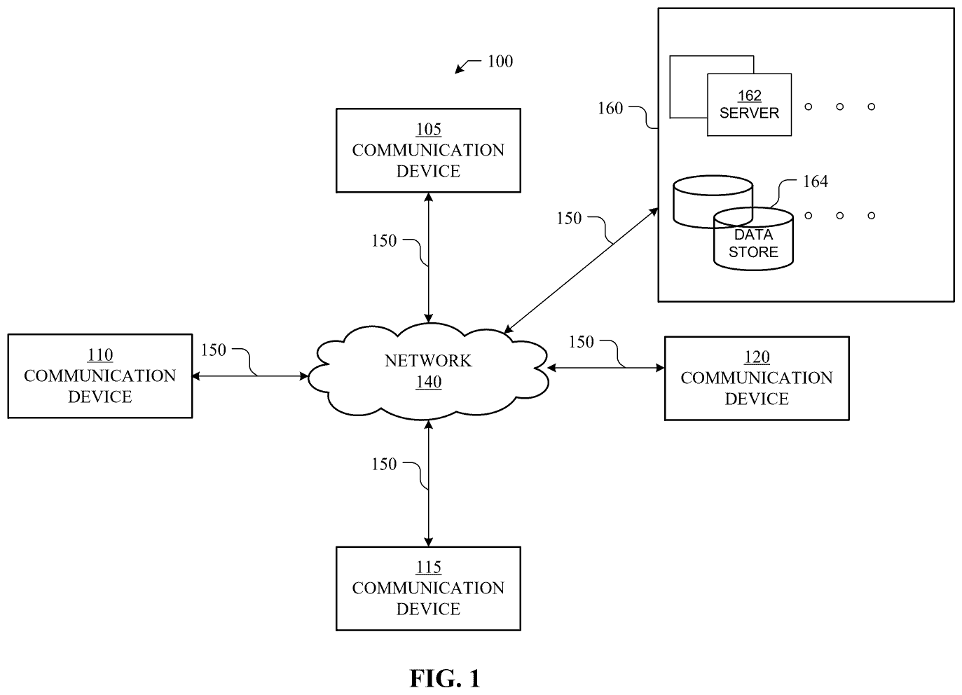

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example, and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example, and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

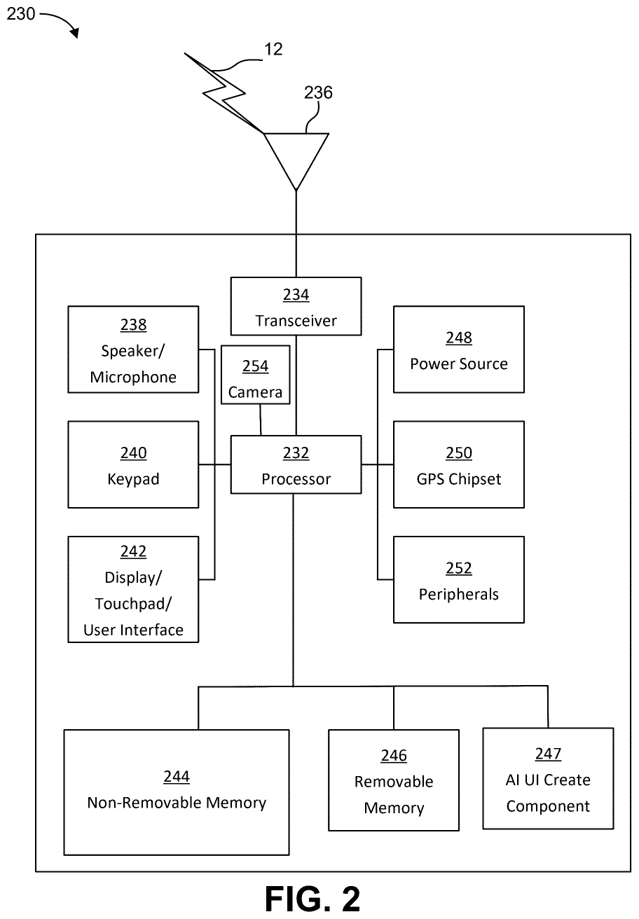

FIG. 2 illustrates a block diagram of an exemplary hardware/software architecture of a communication device such as, for example, user equipment (UE) 230. In some exemplary aspects, the UE 230 may be any of communication devices 105, 110, 115, 120. In some exemplary aspects, the UE 230 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 230 (also referred to herein as node 230) may include a processor 232, non-removable memory 244, removable memory 246, a speaker/microphone 238, a keypad 240, a display, touchpad, and/or user interface(s) 242, a power source 248, a global positioning system (GPS) chipset 250, other peripherals 252, and an AI user interface (UI) create component 247. In some exemplary aspects, the display, touchpad, and/or user interface(s) 242 may be referred to herein as display/touchpad/user interface(s) 242. The display/touchpad/user interface(s) 242 may include a user interface capable of presenting one or more content items and/or capturing input of one or more user interactions/actions associated with the user interface. The power source 248 may be capable of receiving electric power for supplying electric power to the UE 230. For example, the power source 248 may include an alternating current to direct current (AC-to-DC) converter allowing the power source 248 to be connected/plugged to an AC electrical receptacle and/or Universal Serial Bus (USB) port for receiving electric power. The UE 230 may also include a camera 254. In an exemplary embodiment, the camera 254 may be a smart camera configured to sense images/video appearing within one or more bounding boxes. The UE 230 may also include communication circuitry, such as a transceiver 234 and a transmit/receive element 236. It will be appreciated the UE 230 may include any sub-combination of the foregoing elements while remaining consistent with an embodiment.

The processor 232 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 232 may execute computer-executable instructions stored in the memory (e.g., non-removable memory 244 and/or removable memory 246) of the node 230 in order to perform the various required functions of the node. For example, the processor 232 may perform signal coding, data processing, power control, input/output processing, and/or any other functionality that enables the node 230 to operate in a wireless or wired environment. The processor 232 may run application-layer programs (e.g., browsers) and/or radio access-layer (RAN) programs and/or other communications programs. The processor 232 may also perform security operations such as authentication, security key agreement, and/or cryptographic operations, such as at the access-layer and/or application layer for example.

The processor 232 is coupled to its communication circuitry (e.g., transceiver 234 and transmit/receive element 236). The processor 232, through the execution of computer executable instructions, may control the communication circuitry in order to cause the node 230 to communicate with other nodes via the network to which it is connected.

The transmit/receive element 236 may be configured to transmit signals to, or receive signals from, other nodes or networking equipment. For example, in an exemplary embodiment, the transmit/receive element 236 may be an antenna configured to transmit and/or receive radio frequency (RF) signals. The transmit/receive element 236 may support various networks and air interfaces, such as wireless local area network (WLAN), wireless personal area network (WPAN), cellular, and the like. In yet another exemplary embodiment, the transmit/receive element 236 may be configured to transmit and/or receive both RF and light signals. It will be appreciated that the transmit/receive element 236 may be configured to transmit and/or receive any combination of wireless or wired signals.

The transceiver 234 may be configured to modulate the signals that are to be transmitted by the transmit/receive element 236 and to demodulate the signals that are received by the transmit/receive element 236. As noted above, the node 230 may have multi-mode capabilities. Thus, the transceiver 234 may include multiple transceivers for enabling the node 230 to communicate via multiple radio access technologies (RATs), such as universal terrestrial radio access (UTRA) and Institute of Electrical and Electronics Engineers (IEEE 802.11), for example.

The processor 232 may access information from, and store data in, any type of suitable memory, such as the non-removable memory 244 and/or the removable memory 246. For example, the processor 232 may store session context in its memory, (e.g., non-removable memory 244 and/or removable memory 246) as described above. The non-removable memory 244 may include RAM, ROM, a hard disk, or any other type of memory storage device. The removable memory 246 may include a subscriber identity module (SIM) card, a memory stick, a secure digital (SD) memory card, and the like. In other exemplary embodiments, the processor 232 may access information from, and store data in, memory that is not physically located on the node 230, such as on a server or a home computer.

The processor 232 may receive power from the power source 248 and may be configured to distribute and/or control the power to the other components in the node 230. The power source 248 may be any suitable device for powering the node 230. For example, the power source 248 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 232 may also be coupled to the GPS chipset 250, which may be configured to provide location information (e.g., longitude and latitude) regarding the current location of the node 230. It will be appreciated that the node 230 may acquire location information by way of any suitable location-determination method while remaining consistent with an exemplary embodiment.

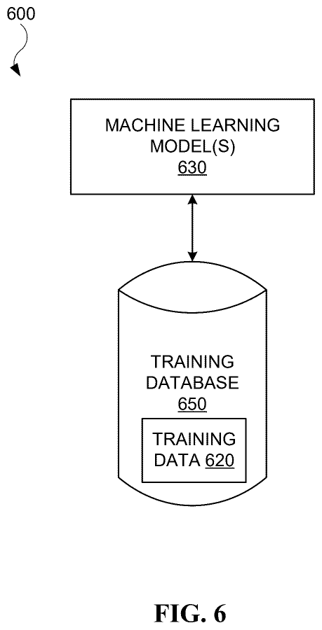

The UE 230 may also include an AI UI create component 247 that may include a machine learning model (e.g., machine learning model 630) and/or AI model configured to determine specifications of the UE 230 and/or demographics of a user of the UE 230 to provide an initial (e.g., a baseline) tailored user interface. The AI UI create component 247 may further monitor the use of the UE 230 to alter/adjust the user interface, which may provide a more personalized version of the user interface (e.g., display/touchpad/user interface(s) 242) for a user of the UE 230. In some examples, the AI UI create component 247 may implement the machine learning model and/or the AI model that may be pre-trained, and/or trained in real time with training data (e.g., training data 620 of FIG. 6) to determine one or more attributes of a user of the UE 230 and/or may alter one or more content items and/or layouts of a user interface tailored for a specific user(s), as described more fully below.

### Exemplary Computing System

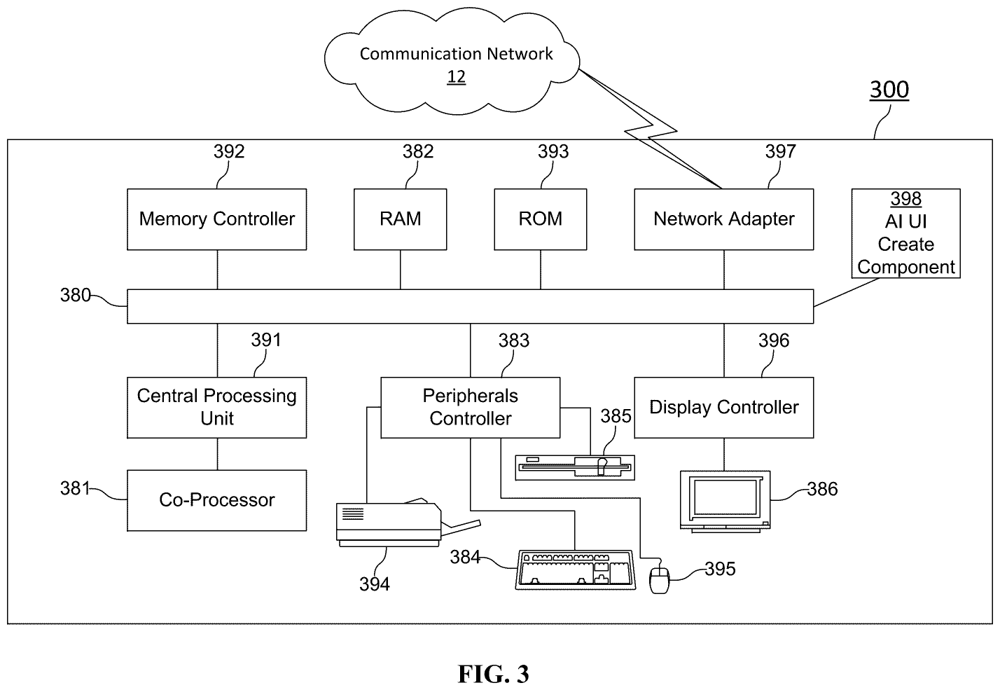

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 391, to cause computing system 300 to operate. In many workstations, servers, and personal computers, central processing unit 391 may be implemented by a single-chip CPU called a microprocessor. In other machines, the central processing unit 391 may comprise multiple processors. Coprocessor 381 may be an optional processor, distinct from main CPU 391, that performs additional functions or assists CPU 391.

In operation, CPU 391 fetches, decodes, and executes instructions, and transfers information to and from other resources via the computer's main data-transfer path, system bus 380. Such a system bus connects the components in computing system 300 and defines the medium for data exchange. System bus 380 typically includes data lines for sending data, address lines for sending addresses, and control lines for sending interrupts and for operating the system bus. An example of such a system bus 380 is the Peripheral Component Interconnect (PCI) bus. The computing system 300 may also include an AI UI create component 398 that may automatically determine one or more attributes of a user of the computing system 300. The AI UI create component 398 that may also determine one or more attributes and/or specifications (e.g., display screen size, processing speed/capacity, bandwidth capability, memory capacity, etc.) of a communication device (e.g., UE 230, computing system 300) to generate a user interface (e.g., an initial user interface, a baseline user interface) tailored to a user of the communication device. The AI UI create component 398 may implement a machine learning model (e.g., machine learning model(s) 630 of FIG. 6) and/or AI model that may be pre-trained, and/or trained in real-time, with training data (e.g., training data 620 of FIG. 6) to determine one or more attributes of a user of the computing system 300, one or more attributes of a communication device and may alter/adjust one or more content items and/or layouts of a user interface (e.g., display 386), as described more fully below.

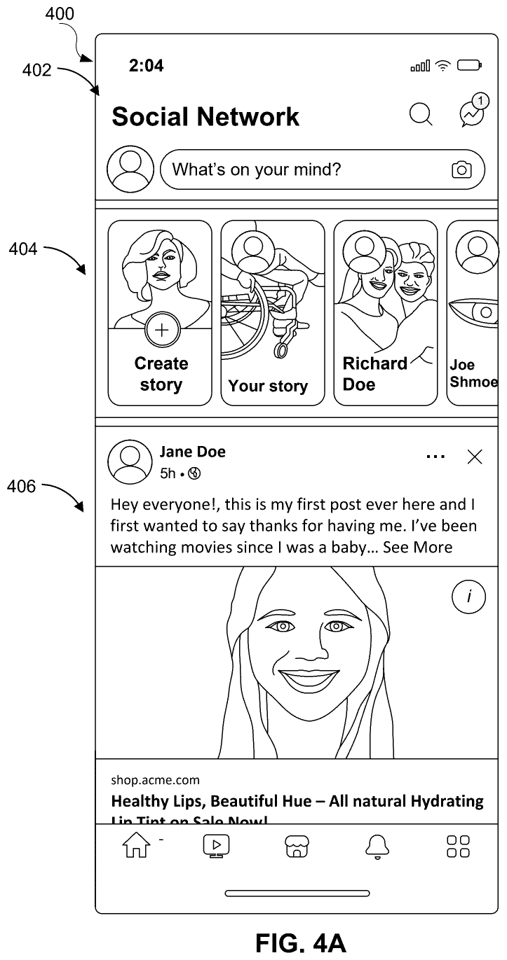

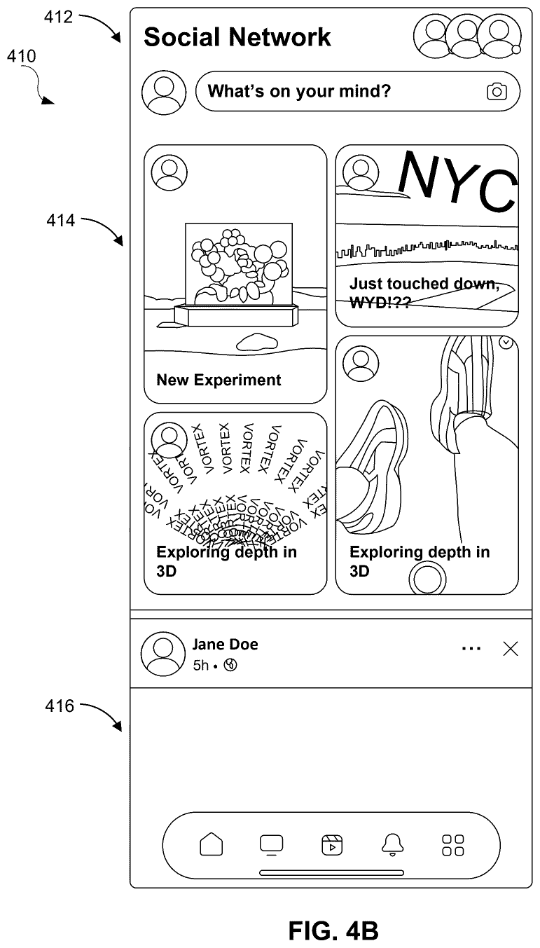

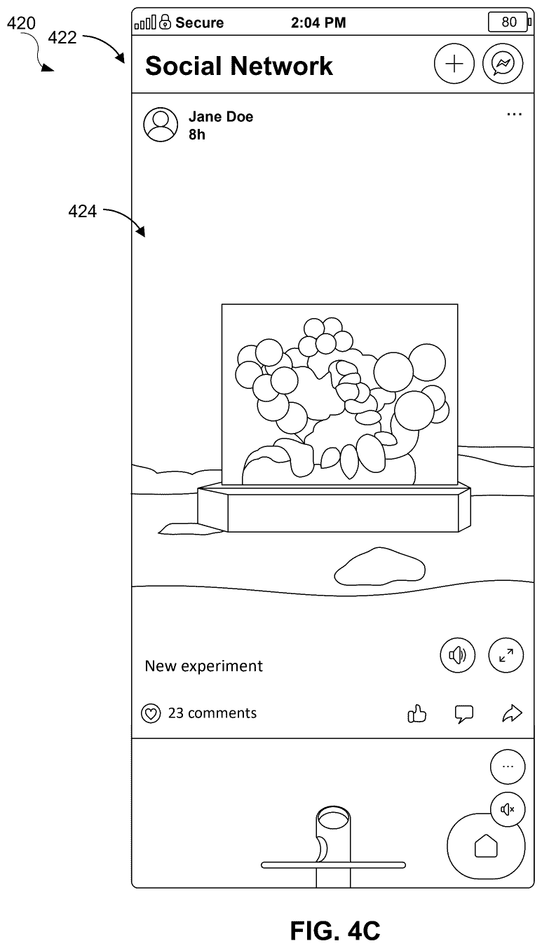

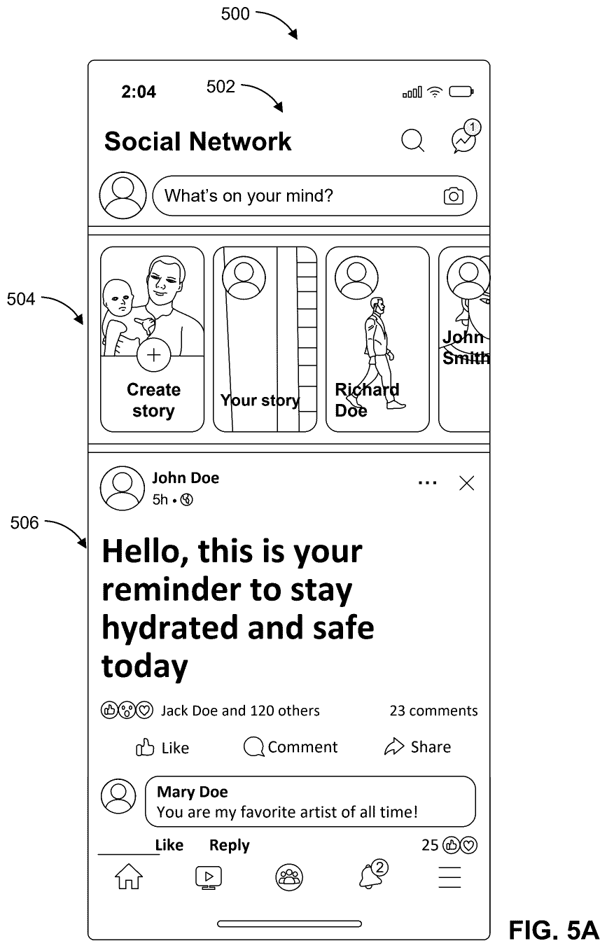

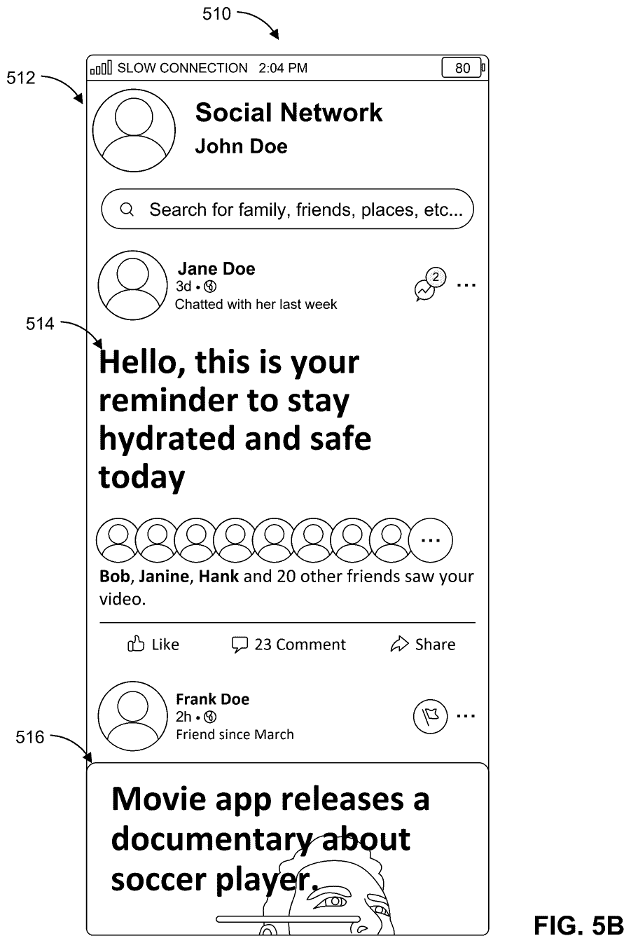

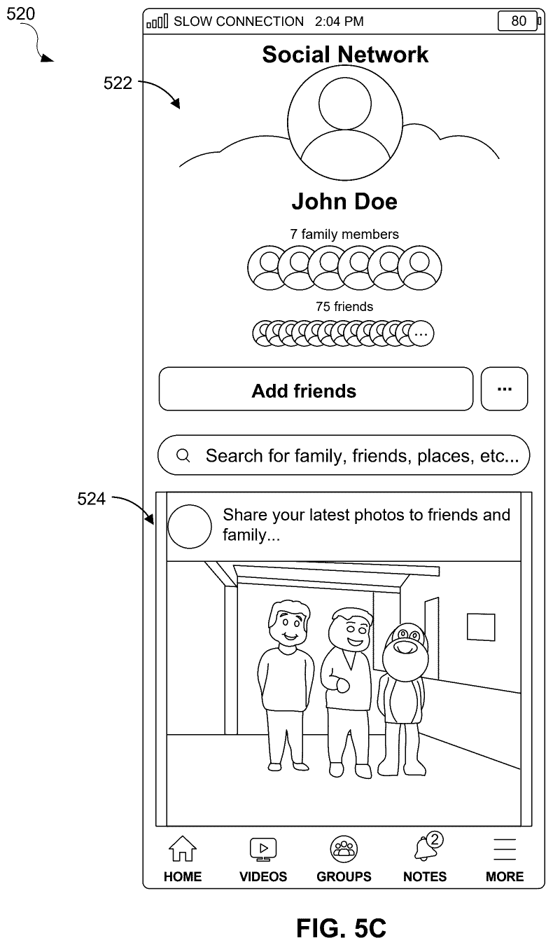

The AI UI create component 398 may also alter/adjust one or more content items and/or layouts of a user interface associated with an application(s) (e.g., app(s)), which may be accessed by the computing system 300. The UI design component 398 may facilitate presentation of a user interface (e.g., an altered or tailored user interface) via display 386. In some examples, the computing system 300 may present a baseline user interface (e.g., UI 400 of FIG. 4A or UI 500 of FIG. 5A). The computing system 300 may receive one or more demographic content inputs associated with a user of a communication device. The AI UI create component 398 may implement a machine learning model (e.g., machine learning model 630) to monitor the use of the computing system 300 and/or one or more applications on, or associated with, the computing system 300. The UI design component 398 may analyze the user's activities associated with the computing system 300, and/or activities of one or more other users of other communication devices (e.g., UE 230), to determine one or more signals which may be utilized to create a user interface tailored to a specific user(s). In some example aspects, the one or more signals may include, but are not limited to, a user's activity on/associated with a communication device(s) (e.g., computing system 300, UE 230), a network signal strength of the communication device(s), one or more technical specifications of the communication device(s), one or more activities of a user(s) associated with one or more applications associated with the communication device(s)), demographic data of a user(s), and/or the like.

In some examples, the AI UI create component 398 may utilize received/detected demographic data to determine one or more attributes of a user(s). In some examples, the demographic data may be data associated with a user profile of the user(s) associated with a network (e.g., system 100). The demographic data may for example include, but is not limited to, age of a user, gender of a user, occupation of a user, location of a user, a device type of a user, an operating system of a device of a user, a network connection associated with a user. In some examples, the one or more attributes may include one or more personal goals of a user associated with the use of one or more applications. The AI UI create component 398 may determine one or more changes or updates to signals to generate an updated tailored user interface in relation to a baseline user interface generated on the basis of initially detected signals. In some examples, the AI UI create component 398 may alter/adjust a user interface to generate a personalized user interface (e.g., UI 410, UI 420, UI 510, UI 520) that may be provided/presented to a user(s) of a communication device (e.g., computing system 300). The computing system 300 may present the one or more personalized user interfaces via the display 386.

For purposes of illustration and not of limitation, for example, a user of a device (e.g., UE 230 or computing system 300) may utilize the device to access one or more applications. The user may input demographic information (e.g., age, marital status, occupation, location of user, gender of user, etc.) into the device and/or an application(s) accessed via, or associated with, the device. The device may utilize the demographic information and one or more technical specifications (e.g., screen size of a display, processing speed, a cellular network technology (e.g., Fourth generation (4G) of cellular network technology, long-term evolution (LTE) network), etc.) of the device itself to generate a baseline user interface (e.g., UI 400 or UI 500) that may be presented to a user (e.g., via a display/touchpad/user interface 242, via display 386). In some examples, the baseline user interface may be an initially created user specific user interface to enable a user to access and/or interact with content associated with the device and/or application.

In some examples, the AI UI create component 398 may initiate a gradual transition from a baseline user interface (e.g., a user specific baseline user interface) to a more personalized user interface that may be more specifically tailored to a particular user in relation to the user specific baseline user interface. For purposes of illustration and not of limitation, for example, the AI UI create component 398 may initially utilize a user interface (e.g., UI 400) to enable a user of a device (e.g., computing system 300) to access the device and/or to engage/interact with content presented via the UI 400. As the AI UI create component 398 determines one or more attributes about the user, the AI UI create component 398 may personalize the user interface further to generate and present another user interface (e.g., UI 410) to the user. As the AI UI create component 398 determines more attributes about the user, the AI UI create component may transition the user interface to another user interface (e.g., UI 420), as described more fully below.

The memories of FIG. 3 may be coupled to system bus 380 and may include RAM 382 and ROM 393. Such memories may include circuitry that allows information to be stored and retrieved. ROMs 393 generally contain stored data that cannot easily be modified. Data stored in RAM 382 may be read or changed by CPU 391 or other hardware devices. Access to RAM 382 and/or ROM 393 may be controlled by memory controller 392. Memory controller 392 may provide an address translation function that translates virtual addresses into physical addresses as instructions are executed. Memory controller 392 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 383 responsible for communicating instructions from CPU 391 to peripherals, such as printer 394, keyboard 384, mouse 395, and disk drive 385.

Display 386, which is controlled by display controller 396, may be used to display visual output generated by computing system 300. Such visual output may include text, graphics, animated graphics, and video. The display 386 may also include or be associated with a user interface. The user interface may be capable of presenting one or more content items and/or capturing input of one or more user interactions associated with the user interface. Display 386 may be implemented with a cathode-ray tube (CRT)-based video display, a liquid-crystal display (LCD)-based flat-panel display, gas plasma-based flat-panel display, or a touch-panel. Display controller 396 includes electronic components required to generate a video signal that is sent to display 386.

Further, computing system 300 may contain communication circuitry, such as for example a network adaptor 397, that may be used to connect computing system 300 to an external communications network, such as network 12 of FIG. 2, to enable the computing system 300 to communicate with other nodes (e.g., UE 230) of the network.

### Exemplary System Operation

Some examples of the present disclosure may provide approaches and techniques to facilitate efficient and reliable mechanisms that provide personalized user interfaces that may be specifically tailored to particular/specific users based, in part, on one or more attributes of a user(s), user device settings and/or device specifications. In some examples, a user may utilize a device and/or application. A baseline user interface may be generated by an AI UI create component (e.g., AI UI create component 247, AI UI create component 398) to enable the user to access the device and/or application and/or to interact with content accessible via the device and/or application. In some examples, the baseline user interface may be a user interface designed for a device and/or application that may be generated/created based on the specifications (e.g., technical specifications) of the device and/or application.

Some example aspects of the present disclosure may enable a communication device (e.g., UE 230, computing system 300) to implement a machine learning model (e.g., machine learning model(s) 630) and/or AI model, which may determine one or more attributes associated with one or more users which may be utilized to determine one or more signals to generate one or more personalized user interfaces that may be specific to corresponding/respective users of a network, platform or the like. The signals may include, but are not limited to, one or more activities of a user(s) (e.g., user activity associated with one or more devices and/or user activity associated with one or more applications), a signal strength(s) of a communication device associated with a user(s), one or more specification(s) (e.g., technical specifications) of a communication device, one or more settings of a communication device, demographic data (e.g., age of a user(s), location of a user(s), occupation of a user(s), gender of a user(s), etc.) and other suitable signals. Additionally, signals may include determined inferences based on user behavior, content preferences (e.g., a type of videos, news, photos, music, games, groups, shopping, etc. that a user(s) may prefer), user engagement with a user interface (e.g., scroll depth, time of day, tap targets associated with actions such as likes, comments, saves, follows, messages, posts, and/or general browsing behavior). Some examples of preferences may include, but are not limited to, shopping preferences such as a type of clothing, sizes, materials, prices, and/or the like that a user(s) may prefer.

In some example aspects, a communication device (e.g., UE 230, computing system 300) may present (e.g., via display/touchpad/user interface 242, display 386) a user interface associated with an application(s). In this regard, the communication device may generate a baseline user interface, for example, in response to detecting/determining one or more items of demographic content associated with a user and/or specifications (e.g., display screen size, display resolution, cellular device capability, Wi-Fi capability, etc.) or settings of the communication device itself. In this example, the demographic content and the specification/settings of the communication device may serve as one or more signals to an AI UI create component (e.g., AI UI create component 247, AI UI create component 398) of the communication device to present the baseline user interface to a user. In some examples, the signals may be determined based on the demographic data and/or device specification content. Additionally, the signals may be determined based on user behavior (e.g., a user frequently making a post at the same time each day such that a user interface may respond to the signal). The signals may also be obtained/collected via user input (e.g., a user utilizing a form/template to input the user's specific shopping preferences). By utilizing the demographic content associated with the user and/or and the communication device specification/settings, the baseline user interface presented via the communication device to a user may be tailored/personalized to the user of the communication device.

In some other examples, the AI UI create component may determine one or more other attributes associated with a user (e.g., determined during a first predetermined time period) that may be utilized by the AI UI create component to alter, change, modify/adjust the baseline user interface to an updated user interface that may be more tailored/personalized to a specific user (e.g., a user of the communication device), as described more fully below. In this regard, for example, different users utilizing a same application (e.g., a social network application, other applications) may be presented with a different user interface(s) associated with the application that may be tailored/personalized to the respective different users. In this manner, the AI UI create component may also provide a user of a user interface (e.g., a baseline user interface, an updated user interface, etc.) the ability to understand a manner in which personalization determinations were made by the AI UI create component. A user may also have the ability to edit, modify, reset, or opt out of personalization determinations generated by the AI UI create component.

In some aspects of the present disclosure, the machine learning model(s) (e.g., machine learning model(s) 630) and/or an AI model(s) may utilize one or more content items such as, for example, one or more user inputs and/or detections of demographic content (e.g., demographic content of a user profile of a user) to determine one or more attributes of the user. In some examples, the machine learning model(s) and/or the AI model(s) may be implemented by an AI UI create component (e.g., AI UI create component 247, AI UI create component 398). For purposes of illustration and not of limitation, as an example of the one or more attributes of a user, consider an example in which one or more items of demographic content include, but are not limited to, a user's age, location, occupation and other content. In this regard, the machine learning model(s) 630 and/or an AI model(s) may utilize the items of demographic content to determine one or more attributes of a user. The attributes determined by the machine learning model(s) 630) and/or the AI model(s) based on analyzing the items of demographic content may include for example, but are not limited to, one or more professional interests of a user (e.g., one or more topics of interest related to the occupation of the user), one of more topics of recreational interest to the user (e.g., topics related to activities or items of common interest to persons around the same age of the user, or the location (e.g., a geographic area/region) of the user). In some examples, the AI UI create component may be capable of generating a personalized user interface based on the attributes. In some other example aspects, the AI UI create component may be capable of utilizing the attributes (e.g., user attributes) and the signals described below to generate a personalized user interface.

In some example aspects, signals may be associated with data (e.g., all data) ingested by the AI UI create component for the purposes of creating and personalizing a user interface for a user(s). The data of the signals may include device information, behavioral/usage information, demographic information, and/or user information. In some example aspects, attributes may include characteristics of a user that may be utilized by the AI UI create component to create a personalized user interface. In some examples, demographic information may be obtained/collected by the AI UI create component. Location information associated with a determined location, by the AI UI create component, of a user may be an attribute of a user. The machine learning model(s) and/or the AI model(s) may determine one or more signals associated with a user(s) and/or a communication device(s) associated with a user(s). The one or more signals may be determined by the machine learning model(s) and/or the AI model(s) by detecting/determining one or more activities of a user (e.g., user activities), one or more activities associated with one or more communication devices (e.g., device activities) of a user(s), a signal strength(s) (e.g., a Received Signal Strength Indication (RSSI), a Reference Signal Received Power (RSRP), a Signal-to-Noise Ratio (SNR)) of a communication device associated with a user(s), one or more specifications/settings of a communication device associated with a user(s), activities of a user(s) (e.g., user application activities) while utilizing one or more applications, and other suitable signals. The RSRP may be a measure of a power level of a received signal from a base station(s), which may be measured in decibel-milliwatts (dBm). A higher RSRP value may indicate a stronger signal. The SNR may be utilized to evaluate the quality of a signal by comparing the level of the desired signal to the level of background noise. A higher SNR may indicate a better quality signal.

In some examples, the signal strength of a communication device (e.g., UE 230, computing system 300) may be determined based on the communication device's connection to a mobile network, a cellular network, telecommunications network/system, a Wi-Fi network, and/or a Bluetooth network. The AI UI create component may be configured to monitor one or more communications devices to determine one or more user activities of a user associated with the communication device(s), and/or one or more device activities of the communication device(s). Some examples of device activities may include, but are not limited to, a last/prior software update on a communication device, a current software version running on a communication device and/or one or more additional applications downloaded on a communication device. Additionally, in some examples, the AI UI create component may be configured to monitor one or more applications that may be on (e.g., stored in a memory device) the one or more communication devices to determine one or more activities of a user utilizing the one or more applications of the communication device(s). As described above, determination of the one or more user activities associated with a communication device, device activities and/or user activities associated with an application(s) may enable the machine learning model(s) and/or the AI model(s) to utilize these determined activities as signals. Some examples of the user activities, as signals, may include, but are not limited to, a scrolling speed ability of a user, a dexterity of a user, a frequency of use of one or more communication devices by a user(s), a frequency of user by a user(s) of one or more applications by a user(s) of a communication device(s), and/or the like. In some examples, a dexterity of a user may include one or more physical characteristics of a user (e.g., physical health such as for example eyesight quality of a user). In this regard, for example, dexterity may refer to the physical ability and coordination of a user's hands, fingers, and/or arms to interact with a device or system. In some examples, the user activities may also include general interests of a user based, in part, on the content interacted with/engaged by a user utilizing one or more communication devices and/or utilizing one or more applications.

Some examples of dexterity according to exemplary aspects of the present disclosure are described as follows. Hand dominance—whether a user is left-handed, right-handed, or ambidextrous. Finger dexterity—the ability to move individual fingers independently, such as for example typing on a keyboard or playing a musical instrument. Hand-eye coordination—the ability to track objects with the eyes and coordinate hand movements to interact with the eyes, such as for example using a touchscreen or playing a video game. Fine motor control—the ability to make precise movements with the hands and/or fingers, such as for example using a stylus or navigating a small menu. Grip strength—the ability to hold onto a device or object firmly, such as for example, holding a smartphone or a tablet. Reach and range of motion—the ability to move the arms and/or hands to interact with different parts of a device or system such as, for example, reaching for a button or scrolling through a long list. Tactile sensitivity—the ability to feel and respond to tactile feedback, such as for example vibrations or texture changes, when interacting with a device.

Referring now to FIG. 4A, a diagram illustrating a baseline user interface in accordance with exemplary aspects of the present disclosure is provided. In the example of FIG. 4A, consider a scenario in which a user may be a wealthy person living in Canada. In this example of FIG. 4A, the AI UI create component (e.g., AI UI create component 247, AI UI create component 398) may detect one or more items of demographic content to determine user attributes and/or determine one or more signals (e.g., user activity signals, device signals, etc.), as described more fully below to utilize to generate the baseline user interface (UI) 400. For example, the AI UI create component may determine based on demographic content one or more user attributes indicating that the user in this example may be female, 22 years old, single (e.g., not married), and may have more than 2,000 friends (e.g., indicated in a friends list) on a social network. The AI UI create component may also determine based on the demographic content and/or determined user activity data that the user may consider herself to be a traveler, trendsetter, and may frequently post in photos and reels (e.g., short-form videos) associated with the social network. The AI UI create component may also determine based on the user activity data that the user in this example may have high engagement with posts of other users that may be considered to be trendsetters.

In this example, the AI UI create component may also detect one or more signals (e.g., device signals) such as, for example, that the user may utilize the latest mobile phone technology (e.g., 4G, LTE, etc.) with the largest screen (e.g., display screen) available for a model of the mobile phone (e.g., UE 230). Additionally, the AI UI create component may determine signals that the user may utilize high-speed Internet, with 24 hours of access. The AI UI create component may utilize a combination of signals in making determinations to generate a personalized user interface. The combination of signals may include, but are not limited to, a combination of demographic data and device data obtained/collected from a user's location and usage of a communication device; data a user(s) added to a profile of the user(s); inferences based on a user's behavior (e.g., the user may engage in content (e.g., advertisements) featuring luxury brands and hotels); and/or user activity (e.g., a user(s) posts photos and/or reels multiple times a week). Based on determined user activity data, the AI UI create component may determine that the user may primarily engage with video content. For instance, the AI UI create component may analyze the user's activity history during a first predetermined time period (e.g., a week, a month, etc.) with regards to the user's interaction with video content.

The AI UI create component may additionally detect one or more signals (e.g., device signals) associated with a communication device of the user having a high usage speed and/or user interface dexterity. High usage speed may refer to high engagement with a user interface. User interface dexterity may refer to leveraging device signals to infer whether a user is causing display of any signals related to dexterity. The AI UI create component may determine other signals associated with user activity of the user associated with the user's common usage functions which may indicate that the user rarely uses a search function, rarely engages with friends on a network (e.g., social network), daily engagement with the user's own social media feed (e.g., updated list of posts or content shared by users on the social network), sharing of posts five times a week, daily reactions to posts (e.g., user engagement that may allow the user to express her emotions and/or opinions about a post(s)), a most common post reaction method using a double-tap on a screen (e.g., a display) of a communication device, and one or more gestures to navigate one or more applications on the communication device.

The AI UI create component may utilize the above described demographic content as user attributes associated with the user and/or the one or more determined signals (e.g., user activity signals, device signals) to generate the baseline UI 400, which may be presented to the user (e.g., via a display/touchpad/user interface 242, display 386). As an example, the baseline UI 400 may be presented to the user during the user's initial use of an application that may be associated with the baseline UI 400.

In some example aspects, the AI UI create component may be configured to receive or detect additional demographic data. For example, the additional demographic data may be detected/determined as additional user attributes during a predetermined time period (e.g., a week, a month, two months, etc.) of the user utilizing the baseline UI 400. In this example, the one or more items of detected/determined demographic data, associated with the user attributes may include the user's sex (e.g., female), age (e.g., 22 years old), marital status (e.g., single), occupation (e.g., traveler or trendsetter) and other demographic data. The AI UI create component may monitor the user's use of the application (e.g., social media application, other applications) to determine that the user has more than 3,000 friends in the user's list of friends (e.g., a social network friends list). During the predetermined time period, the AI UI create component may detect one or more additional signals associated with other user activity signals associated with the user's engagement with other/additional posts of other trendsetters and/or additional engagement with other video content by the user as well as data indicating the users increased interest in one or more other reels (e.g., reel(s) 404) and/or less interest with navigation icons (e.g., icons in header 402) in the baseline UI 400. The AI UI create component may also determine that one or more signals (e.g., device signals) indicating that the Internet speed of the communication device of the user is lowered/decreased (e.g., low-speed Internet and 12-hour Internet access) during the predetermined time period high-speed internet and 24-hour access, that the usage speed of the device changed (e.g., the usage speed decreased) and that the user interface dexterity and common usage functions of the baseline UI 400 changed during the predetermined time period.

By analyzing the determined user attributes, user activity signals, and/or device activity signals during the predetermined time period associated with the user utilizing the baseline UI 400, the AI UI create component may utilize may alter, modify or update the content and/or layout elements of the baseline UI 400 to generate an updated user interface such as for example UI 410 as show in FIG. 4B. The UI 410 may include more one or more additional reels (e.g., reel(s) 414) and/or less/fewer navigation icons such as for example less icons presented in header 412 as compared to the icons presented header 402 of the baseline UI 400. In this example of FIG. 4B, the AI UI create component may alter displayed posts 406 of baseline UI 400 to include a post 416 with less photos and/or video content and with less text-based content in relation to post 406.

In some other example aspects, the AI UI create component may determine one or more additional user attributes based on other determined user interests of the user, and in this regard, the AI UI create component may determine that the header 402 of baseline UI 400 may be altered to include a feed 412, which may include more reels (e.g., reels 414). Based on the determined additional user attributes, which may be determined during another predetermined time period (e.g., or upon expiration of the first predetermined time period described above, the AI UI create component may further alter/update the UI 410 to include an updated personalized UI 420 that may include a header 422 and a more immersive video feed 424 than a video feed that may be presented in the UI 410 of FIG. 4B. In the example of FIG. 4C, the immersive video feed 424 may be dependent on user interface gestures. In this regard, for example, the UI 420 may be an updated/altered UI in relation to the UI 410 having an immersive video feed 424 that may be dependent on user gestures to access the immersive video feed 424 and/or to facilitate navigation of or access to one or more features of an application (e.g., a social network application) associated with the UI 420.

Referring now to FIG. 5A, a diagram illustrating a baseline user interface in accordance with exemplary aspects of the present disclosure is provided. In the example of FIG. 5A, consider a scenario in which a user may be a 74 year-old male living in Brazil. In this example of FIG. 5A, the AI UI create component (e.g., AI UI create component 247, AI UI create component 398) may detect one or more items of demographic content to determine user attributes and/or determine one or more signals (e.g., user activity signals, device signals, etc.), as described more fully below to utilize to generate the baseline UI 500. For example, based in part on determined demographic content (e.g., determined based on a user profile) associated with user attributes, the AI UI create component may determine that the user in this scenario may have retired from the military and may have a marital status of single. Additionally, the AI UI create component may determine user attributes, based on the demographic content, indicating that the user in this example may have less than 200 friends in a friends list associated with a network (e.g., a social network), and that most of friends indicated in the friends list may be acquaintances.

In the example of FIG. 5A, by analyzing one or more device specifications and/or device settings, the AI UI create component may determine one or more signals indicating that a communication device (e.g., UE 230 or computing system 300) of the user is a generation prior to the latest generation of a same type of the communication device. The AI UI create component may determine based on the device specifications and/or device settings one or more signals (e.g., device signals) indicating that the communication device of the user may have a small screen and limitations on the Internet speed of the communication device that may create latency issues with the communication device and/or signal degradation (e.g., a low signal strength). Additionally, device signals may indicate that the communication device of the user may have spotty or intermittent Internet access. In this example, the AI UI create component may also determine user activity signals associated with the user's network use (e.g., social network use), which may include higher user engagement/interaction with updates/posts from friends, and sporadic original posts or updates by the user, as well as frequent engagement with comments posted on the network by friends. The AI UI create component may also determine signals indicating that the user may have difficulty understanding mobile UI patterns and/or that the user may utilize accessibility features, such as larger font sizes based in part on analyzing user historical data associated with utilizing the communication device on the network in prior time periods.

In the example of FIG. 5A, the baseline UI 500 may be presented (e.g., via display/touchpad/user interface 242, display 386) to the user of the communication device during the user's initial use of an application (e.g., a social network application). For purposes of illustration, and not of limitation, for example, the application associated with FIG. 5A, may be the same application associated with FIG. 4A. The user that is a 74 year-old male living in Brazil associated with FIG. 5A is a different user than the wealthy person/user living in Canada associated with FIG. 4A. The AI UI create component may utilize the user attributes associated with the demographic content and the one or more signals (e.g., device signals, user activity signals, etc.) described above with regards to FIG. 5A, to generate the baseline UI 500 that may be tailored to the user (e.g., the 74 year old male living in Brazil). For example, the AI UI create component may create the baseline UI 500 with a header 502 including one or more icons, and a story feed 504 as well as posts 506 in a larger preferred font of the user than a default font size.

Although the application associated with FIG. 5A and the application associated with FIG. 4A may be the same application (e.g., a social network application), the baseline user interfaces 400 and 500 (e.g., the initial user interfaces presented to the user associated with the application) may be different and tailored to the specific users (e.g., the wealthy person living in Canada, the 74 year old male living in Brazil) respectively.

The AI UI create tool may be configured to receive/detect one or more additional items of demographic content during a first predetermined time period in which the user of the communication device may utilize the baseline UI 500. In this example, the one or more items of demographic content may be associated with user attributes indicating one or more updates and/or changes associated with the user such as for example, an indication that user's marital status has changed (e.g., married) and/or the user's occupation (e.g., user's occupation is a business manager and is no longer retired) has changed and been updated (e.g., updated in a user profile). Additionally, during the first predetermined time period, the AI UI create component may monitor the user's use of the application (e.g., a social network application, etc.) to determine that the user now has less than 150 friends in the user's friends list, many of whom may be acquaintances.

During the first predetermined time period, the AI UI create component may detect/determine one or more other signals. In this example, the one or more other signals may include other device settings (e.g., a new model of the same type of the communication device, increased screen size, improved Internet capability) and one or more other user activity signals associated with the user's network behavior (e.g., social media application behaviors) such as for example high engagement with updates from friends, increased user generation of original posts and/or updates, less frequent engagement with comments of friends, difficulty/challenges comprehending UI patterns (e.g., icons or concepts of using a user interface), and/or challenges with the usage of accessibility features (e.g., user desires larger font size than a default font size). In this example of FIG. 5A, in response to analyzing the other user attributes and other signals determined during the first predetermined time period, the AI UI create component may determine that the user (e.g., the 74 year old male living in Brazil) may be interested in a simplified presentation of the baseline user interface, including photos of friends, and/or layouts of user interface that facilitate intuitive user engagement with text posts and other features. In this example, the AI UI create component may alter/change/update the content items and/or layout of the baseline user interface UI 500 to generate tailored/user specific UI 510 of FIG. 5B to simplify the header (e.g., removing the story feed 504 and/or icons from header 502) of the baseline UI 500 to increase the size of photos of friends and/or the size of posts (e.g., posts 516) for easier user recognition/user interaction, and/or to more prominently (e.g., larger font size in relation to a font size of the baseline UI 500) display the text of posts (e.g., post 514) and/or the caption of posts (e.g., posts 516) via the UI 510.

In this example, the AI UI create component may determine, based on the user's interests, determined by monitoring the other user attributes (e.g., user's use of the application), and/or the other signals such as, for example, user activity signals and/or device signals (e.g., the user's device capabilities and/or network capabilities) that the user may benefit from a more immersive header (e.g., header 512) that may increase the user's sense of self presented in the UI 510 and which may provide easier access to recent photos to help the user share the photos across a network/platform (e.g., system 100). As such, in this example, the AI UI create component may alter the baseline UI 500 to generate the UI 510 to be more personalized to the user.

In a similar manner, the AI UI create component may monitor/detect, during a second predetermined time period (e.g., upon expiration of the first predetermined time period), one or more other/additional user attributes. The one or more other/additional user attributes may be associated with updates to demographic content of the user and/or detection of one or more additional/other signals associated with the user (e.g., user activity settings) and/or the device of the user (e.g., device settings) to alter/adjust or update the UI 510 to the UI 520 as shown in FIG. 5C. In the example of FIG. 5C, the AI UI create component may generate the header 522 in UI 520 to be more personalized to the user in relation to the header 512 of FIG. 5B. In this regard, the header 512 may for example include the user's name (e.g., John Doe a fictitious person), with the user's picture more centrally/prominently displayed). The header 522 may further include icons associated with the user's family members (e.g., 7 family members) and/or friends (e.g., 75 friends) that may be in the user's friends list associated with the application (e.g., social network application). The UI 520 may further include a view of a recent photo (e.g., photo 524) associated with the device and/or the application. The AI UI create component may enable easier sharing of the photo 524 in the UI 520 by having a banner alerting the user that the user may share the photo 524. The UI 520 may also indicate, based on the determine device signals during the second predetermined time period that the communication device has a slow connection with the network/platform (e.g., system 100).

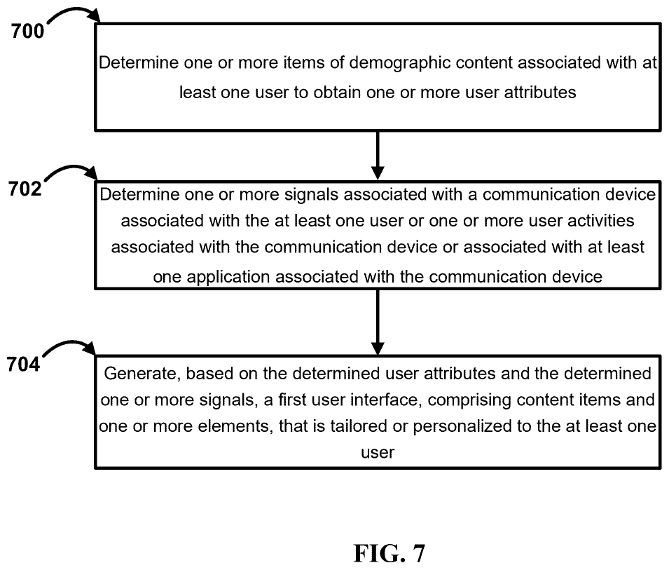

FIG. 6 illustrates an example of a machine learning framework 600 including machine learning model(s) 630 and a training database 650 in accordance with one or more examples of the present disclosure. The training database 650 may store training data 620. In some examples, the machine learning framework 600 may be hosted locally in a computing device or hosted remotely. By utilizing the training data 620 of the training database 650, the machine learning framework 600 may train the machine learning model(s) 630 to perform one or more functions, described herein, of the machine learning model(s) 630. In some examples, the machine learning model(s) 630 may be stored in a computing device. For example, the machine learning model(s) 630 may be embodied within a communication device (e.g., UE 230). In some other examples, the machine learning model(s) 630 may be embodied within another device (e.g., computing system 300). Additionally, the machine learning model(s) 630 may be processed by one or more processors (e.g., processor 232 of FIG. 2, co-processor 381 of FIG. 3). In some examples, the machine learning model(s) 630 may be associated with operations (or performing operations) of FIG. 7. In some other examples, the machine learning model(s) 630 may be associated with other operations.

In an example, the training data 620 may include attributes of thousands of objects. For example, the objects may be specifications (e.g., technical specifications) of communication devices, settings of communication devices, posters, brochures, billboards, menus, goods (e.g., packaged goods), books, groceries, Quick Response (QR) codes, smart home devices, home and outdoor items, household objects (e.g., furniture, kitchen appliances, etc.) and any other suitable objects. In some other examples, the objects may be smart devices (e.g., UEs 230, communication devices 105, 110, 115, 120), persons (e.g., users), newspapers, articles, flyers, pamphlets, signs, cars, content items (e.g., messages, notifications, images, videos, audio), and/or the like. Attributes may include, but are not limited to, the size, shape, orientation, position/location of the object(s), etc. The training data 620 employed by the machine learning model(s) 630 may be fixed or updated periodically. Alternatively, the training data 620 may be updated in real-time based upon the evaluations performed by the machine learning model(s) 630 in a non-training mode. This may be illustrated by the double-sided arrow connecting the machine learning model(s) 630 and the stored training data 620.

Some other examples of the training data 620 may include, but are not limited to, items of content determined as being associated with one or more items of demographic data of one or more users (e.g., age, gender, marital status, occupation, recreational interests, location, etc.) and/or one or more signals (e.g., technical specifications/technical settings of one or more communication devices (e.g., different types/models of communication devices), a network signal (e.g., network bandwidth) capability of networks in which the communication devices may be connected, activities of users with one or more applications and/or one or more communication devices based on user interaction history during time periods). The training data 620 may also include other content such as, for example, data indicating scrolling speeds of user interfaces by users, accuracy in selecting a point target on a device screen, users utilization/access of icons associated with applications and/or devices to navigate a user interface(s), and/or utilization of gestures by one or more users to navigate a user interface(s) associated with an application(s) and/or a device. Additionally or alternatively, training data 620 may include, but is not limited to, localized user behaviors (e.g., understanding collective behavior of a specific user demographic, for example understanding whether all users within a particular region prefer one type of food over another) and/or user research findings (e.g., understanding user insights from studies that may be applied to certain demographics in an instance in which data may not be sourced from available signals, for example whether users of a certain age prefer larger text sizes). The training data 620 of the training database 650 may be utilized, in part, to pre-train, and/or train in real-time, the machine learning model(s) 630.

By utilizing the example aspects of the present disclosure providing artificial intelligence and/or machine learning approaches to automatically personalize user interfaces for a user(s) of a communication device, which may enable provision of a more robust, efficient and user-friendly user interfaces for user interactions/engagement with communication devices and/or applications than conventional/existing approaches that may require a user (e.g., a user interface designer) to manually adjust (e.g., via a template or the like) a format(s) of a user interface. The example aspects of the present disclosure may provide technical improvements in the field of user interface technology by enhancing a user experience by enabling users to interact with dynamically tailored user specific user interfaces in real time. The generated user specific user interfaces may cater to the preferences, needs and desires of specific users associated with a network, platform, or the like and may enable user interaction with these user interfaces to be less cumbersome for the intended user of a user specific user interface. In this regard the automatic personalized user interfaces, generated by the example aspects of the present disclosure, may be specific and tailored to different users.

Additionally, the example aspects of the present disclosure may enhance user interface technology by enabling improvements of task completion(s) by users, improvements to content discoverability and relevance and may improve user accessibility of content via user interfaces. Furthermore, the example aspects of the present disclosure may provide additional user interface technology benefits by reducing a need to design a single user interface as one size fits all user interface for all users of a network/platform and instead may cater to a user's specific needs and/or desires. The example aspects of the present disclosure may facilitate creation of a dynamic design system that enables the creation of scalable user interfaces that may be generated based on AI decisions/determinations. The example aspects of the present disclosure may also build constraints that enables AI to make user interface decisions that encourage good design principles and ethics, while mitigating against undesirable user interface patterns. The example aspects of the present disclosure may leverage AI decisions/determinations as part of a rapid feedback loop that informs iteration of a design system to optimize a user interface(s) faster than creation of a current product cycle(s).

FIG. 7 illustrates an example flowchart illustrating operations for generating personalized user interfaces according to an example of the present disclosure. At operation 700, a device (e.g., AI UI create component 247, AI UI create component 398) may determine one or more items of demographic content associated with at least one user to obtain one or more user attributes. At operation 702, a device (e.g., AI UI create component 247, AI UI create component 398) may determine one or more signals associated with a communication device associated with the at least one user or one or more user activities associated with the communication device or associated with at least one application associated with the communication device. In some examples, the communication device may be UE 238 or computing system 300. In some examples, the at least one application may be a social network application.

At operation 704, a device (e.g., AI UI create component 247, AI UI create component 398) may generate, based on the determined user attributes and the determined one or more signals, a first user interface, including content items and one or more elements, that is tailored or personalized to the at least one user. In some examples, the first user interface may be a baseline user interface (e.g., baseline UI 400, baseline UI 500). The device may generate the first user interface prior to the at least one user initially utilizing the first user interface. The one or more specifications may include, but are not limited to, at least one of a size of a user interface, a size of a display of the communication device, a determined signal strength of the communication device connected to a network, a determined bandwidth of the communication device when connected to the network, or a latency of the communication device when connected to the network (e.g., system 100).

In some example aspects, the AI UI create component may begin customizing a baseline user interface to an updated personalized user interface immediately upon a user's use or interaction with an application and/or a device. In some other examples, the AI UI create component may begin customizing the baseline user interface to an updated personalized user interface after a preset amount of time of use or user interaction with the application and/or the device by the user. In another example aspect, the AI UI create component may begin customizing the baseline user interface to an updated personalized user interface after a preset number of uses of the baseline user interface by the user. In other examples, the AI UI create component may begin customizing the baseline user interface in response to one or more factors (e.g., combination of factors), such as a number of uses of the baseline user interface or the amount of time spent using the baseline user interface.

In an example, the AI UI create component may determine that a user may not utilize or interact with a component/element of a baseline user interface (e.g., baseline UI 400, baseline UI 500) associated with an application (e.g., a social network application). In this example, since the user may not interact with the component/element in the baseline user interface, the AI UI create component may alter the baseline user interface to minimize the component/element or remove the component/element from an updated user interface (e.g., UI 510, etc.) associated with the baseline user interface. On the other hand, the AI UI create component may increase a size of one or more components/elements that a user frequently interacted with in the baseline user interface for inclusion in a generated updated personalized user interface. In another example aspect, the AI UI create component may alter the baseline user interface to move commonly/frequently used components/elements to a more prominent location in the updated personalized user interface.

The AI UI create component may consider other factors to determine a type of customization or rate of customization of a personalized user interface. The AI UI create component may provide customization of a user interface in a manner that may not disrupt the use of a device and/or application. The customization type or rate of customization of a user interface may be dependent on the device and/or the application. Consider an example in which a user interface associated with an application may have a prominent search functionality. In this example, the user interface may have an icon, or a component associated with the search function that may be prominently displayed in the user interface. The AI UI create component may monitor the use of the user interface and may determine that the user of the device and/or the application may not frequently utilize the search function of the user interface. In this example, the AI UI create component may alter an updated user interface to minimize the search function's icon or component from being prominently displayed in the updated user interface to being less prominently displayed in the updated user interface. In this example, each time the user of the updated user interface accesses the updated user interface, the search function's icon or component may be less prominently displayed than the previous time of accessing the updated user interface.

Consider an example which may include a 65-year-old woman from Brazil. In this example, the woman's communication device may have a poor network connection. The woman may additionally have little acquaintance/experience with mobile user interfaces. The woman in this example may additionally need guidance on the use of a communication device and/or application. The guidance may be provided via a user interface based on the AI UI create component considering these factors and generating the user interface. In this example, the woman may not be familiar with one or more functions provided in by user interfaces, such as a search function or a save function. In this example, the AI UI create component may determine that the woman is not familiar with the functions and/or may need guidance regarding the use of the user interface.

In this regard, the AI UI create component may be configured to present one or more icons with labels that may instruct the woman on the functions served by utilizing the one or more icons. In an example, a label(s) may be attached to an icon(s) indicating that the icon(s) may be used for a search (e.g., a search for other users on the network, a search for content items, etc.). In another example, a label may be attached to an icon indicating that the icon may be used for a save feature. In another example, a label may be attached to a component of the user interface generated by the AI UI create component indicating that the component is a feed (e.g., a news feed). In this example, the AI UI create component may be configured to determine that the woman may have poor dexterity, which may make it difficult for the woman to perform tasks involving movements. In this regard, the AI UI create component may alter a generated user interface to increase button sizes or font sizes in another generated personalized user interface on behalf of the woman.

As another example, consider an instance in which one or more icons that the woman from Brazil typically interacts with in a user interface to perform a search function may be small (e.g., a size of the icons is small). In this example, the AI UI create component may be configured to generate a personalized user interface that prioritizes display of icons such that the icons are more prominent/larger (e.g., to enable the woman to more easily perform search functions or other functions via the personalized user interface).

Consider another example in which a user of a device consumes content using a user interface. The AI UI create component may determine that the user may prefer consuming video content. The AI UI create component may alter the user interface to minimize text on the user interface to enable the user to consume more video content easily in a user-friendly manner in a generated personalized user interface. The AI UI create component may be configured to choose video content to be displayed to a user in the personalized user interface based on one or more attributes of the user. The AI UI create component may further be configured to determine a format of the video content or a format of the prior user interface that the user interacted with to enable the personalized user interface to maximize the ease of a user in consuming content via the personalized user interface.

Consider another example in which a user may browse a social network on a mobile phone in rural Brazil in which the Internet connection with the mobile phone may be spotty (e.g., a weak signal strength). The AI UI create component may determine one or more user activities associated with a social network. For instance, the AI UI create component may determine that the user may have been on a social network for eight years, and that the user may mainly use the social network for keeping in touch with family or friends, including the user's children and the user's grandchildren who live abroad. The user may also use the social network for keeping up to date with news from Brazil or around the world. The user may post on the social network sporadically, and the user's interactions may be limited to actions such as for example Likes, Shares, or Comments. In this example, the user may consider that interacting with posts or comments to be challenging because of a small device screen, low bandwidth, or small icons. The user may desire to see all posts from family on the user's news feed and may not want to miss any content. Additionally, the user may not know how to manage a friends list. The user may not know how to hide content the user is disinterested in.

In this example, the AI UI create component may be configured to alter a prior user interface presented to the user in rural Brazil generate a more personalized user interface that may display large components with high contrast or high resolution. Additionally, the AI UI create component may enable the personalized user interface to display simple interface components with optimized images transfer/sending of the images low bandwidth. The personalized user interface may additionally provide a lower number of videos on a news feed than normal. The AI UI create component may be configured to alter the personalized user interface to another tailored user specific user interface to simplify prioritization of posts that may be of most interest to the user, which may include an expanded comments section in which comments from family members may be displayed in a prioritized manner in the tailored user specific user interface. Additionally, due to the user's preference for simple interactions, the tailored user specific user interface may display simplified interaction buttons.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
determining one or more items of demographic content associated with at least one user to obtain one or more user attributes;
determining one or more signals associated with a communication device associated with the at least one user or one or more user activities associated with the communication device or associated with at least one application associated with the communication device; and
generating, based on the determined user attributes and the determined one or more signals, a first user interface, comprising content items and one or more elements, that is tailored or personalized to the at least one user.

2. The method of claim 1, further comprising:
performing the generating of the first user interface prior to the at least one user initially utilizing the first user interface.

3. The method of claim 1, further comprising:
presenting the first user interface to the at least one user to enable the at least one user to interact with the first user interface.

4. The method of claim 1, further comprising:
determining, during a first predetermined time period, other items of demographic content associated with the at least one user to obtain other user attributes;
determining, during the first predetermined time period, other signals associated with the communication device or other user activities associated with the communication device or associated with the at least one application; and
generating, based on the determined other user attributes and the determined other signals, a second user interface, comprising at least one other data item or a subset of the content items and one or more other elements, that is tailored or personalized to the at least one user.

5. The method of claim 4, further comprising:
determining the other user activities based in part on one or more determined interactions by the at least one user with the content items and the one or more elements associated with the first user interface.

6. The method of claim 4, wherein:
the first user interface comprises a baseline user interface: and
the second user interface comprises an updated user interface of the baseline user interface.

7. The method of claim 1, wherein:
the one or more signals comprises one or more of specifications of the communication device or device settings associated with the communication device.

8. The method of claim 7, wherein:
the one or more specifications comprise at least one of a size of a user interface, a size of a display of the communication device, a determined signal strength of the communication device connected to a network, a determined bandwidth of the communication device when connected to the network, or a latency of the communication device when connected to the network.

9. The method of claim 1, wherein:
the items of demographic content comprises one or more of an age of the at least one user, a marital status of the at least one user, an occupation of the at least one user, one or more determined interests of the at least one user, or a determined location of the at least one user.

10. The method of claim 1, wherein:
the user activities comprise one or more of a determined scrolling speed of user interfaces by the at least one user during a predetermined time period, a level of experience by the at least one user with other user interfaces during the predetermined time period or one or more determined goals of the at least user associated with the at least one application during the predetermined time period.

11. An apparatus comprising:
one or more processors; and
at least one memory storing instructions, that when executed by the one or more processors, cause the apparatus to:
determine one or more items of demographic content associated with at least one user to obtain one or more user attributes;
determine one or more signals associated with a communication device associated with the at least one user or one or more user activities associated with the communication device or associated with at least one application associated with the communication device; and
generate, based on the determined user attributes and the determined one or more signals, a first user interface, comprising content items and one or more elements, that is tailored or personalized to the at least one user.

12. The apparatus of claim 11, wherein when the one or more processors further execute the instructions, the apparatus is configured to:
perform the generate the first user interface prior to the at least one user initially utilizing the first user interface.

13. The apparatus of claim 11, wherein when the one or more processors further execute the instructions, the apparatus is configured to:
present the first user interface to the at least one user to enable the at least one user to interact with the first user interface.

14. The apparatus of claim 11, wherein when the one or more processors further execute the instructions, the apparatus is configured to:
determine, during a first predetermined time period, other items of demographic content associated with the at least one user to obtain other user attributes;
determine, during the first predetermined time period, other signals associated with the communication device or other user activities associated with the communication device or associated with the at least one application; and
generate, based on the determined other user attributes and the determined other signals, a second user interface, comprising at least one other data item or a subset of the content items and one or more other elements, that is tailored or personalized to the at least one user.

15. The apparatus of claim 14, wherein when the one or more processors further execute the instructions, the apparatus is configured to:
determine the other user activities based in part on one or more determined interactions by the at least one user with the content items and the one or more elements associated with the first user interface.

16. The apparatus of claim 14, wherein:
the first user interface comprises a baseline user interface: and
the second user interface comprises an updated user interface of the baseline user interface.

17. The apparatus of claim 11, wherein:
the one or more signals comprises one or more of specifications of the communication device or device settings associated with the communication device.

18. A non-transitory computer-readable medium storing instructions that, when executed, cause:
determining one or more items of demographic content associated with at least one user to obtain one or more user attributes;
determining one or more signals associated with a communication device associated with the at least one user or one or more user activities associated with the communication device or associated with at least one application associated with the communication device; and
generating, based on the determined user attributes and the determined one or more signals, a first user interface, comprising content items and one or more elements, that is tailored or personalized to the at least one user.

19. The computer-readable medium of claim 18, wherein the instructions, when executed, further cause:
performing the generating of the first user interface prior to the at least one user initially utilizing the first user interface.

20. The computer-readable medium of claim 19, wherein the instructions, when executed, further cause:
determining, during a first predetermined time period, other items of demographic content associated with the at least one user to obtain other user attributes;
determining, during the first predetermined time period, other signals associated with the communication device or other user activities associated with the communication device or associated with the at least one application; and
generating, based on the determined other user attributes and the determined other signals, a second user interface, comprising at least one other data item or a subset of the content items and one or more other elements, that is tailored or personalized to the at least one user.
